(19) United States
(12) Patent Application Publication
(10) Pub. No.: US 2026/0142543 A1
(43) Pub. Date: May 21, 2026

(54) LINEAR VIBRATION MOTOR AND METHOD FOR MANUFACTURING LINEAR VIBRATION MOTOR

(71) Applicant: Murata Manufacturing Co., Ltd., Nagaokakyo-shi (JP)

(72) Inventors: Kazuhide Takata, Nagaokakyo-shi (JP); Takeshi Kurita, Nagaokakyo-shi (JP); Keiji Fujioka, Nagaokakyo-shi (JP)

(21) Appl. No.: 19/448,605

(22) Filed: Jan. 14, 2026

Related U.S. Application Data
(63) Continuation of application No. PCT/JP2024/027856, filed on Aug. 5, 2024.

(30) Foreign Application Priority Data
Aug. 9, 2023 (JP) 2023-129730

(51) Int. Cl. H02K 33/18; H02K 5/04; H02K 15/03; H02K 15/148

(52) U.S. Cl. CPC H02K 33/18; H02K 5/04; H02K 15/03; H02K 15/148

(57) ABSTRACT

A linear vibration motor that includes: a cylinder having a through-hole with a first open end and a second open end in a first direction; a mover magnet in the through-hole of the cylinder; a first stator magnet at the first open end; a second stator magnet at the second open end; a coil conductor at an outer circumferential surface of the cylinder; and a casing that accommodates the cylinder, the mover magnet, the first stator magnet, the second stator magnet, and the coil conductor, wherein a length A of the cylinder in the first direction, a length B of the casing in the first direction, and a length C of the first stator magnet and the second stator magnet in the first direction satisfy a relationship of A<B<A+2C.

### CROSS REFERENCE TO RELATED APPLICATIONS

The present application is a continuation of International application No. PCT/JP2024/027856, filed Aug. 5, 2024, which claims priority to Japanese Patent Application No. 2023-129730, filed Aug. 9, 2023, the entire contents of each of which are incorporated herein by reference.

### TECHNICAL FIELD

The present disclosure relates to a linear vibration motor, and a method for manufacturing a linear vibration motor.

### BACKGROUND ART

Patent Document 1 describes a vibration actuator. The vibration actuator includes a hollow cylindrical shaft.

Stationary magnets are disposed at both ends in the axial direction of the shaft. Inside the shaft, a moving magnet movable in the axial direction of the shaft is disposed between the magnets at both ends.

The vibration actuator has a magnetic spring mechanism using a repulsive force caused between the stationary magnets and the moving magnet.

Patent Document 1: Japanese Unexamined Patent Application Publication No. 2019-195787

### SUMMARY OF THE DISCLOSURE

However, an existing structure including a linear-vibration-motor vibration actuator described in Patent Document 1 includes, for example, a set screw serving as an adjusting member that adjusts the positions of the stationary magnets in the axis direction of the shaft. The bracket thus has a longer length in the axial direction than the shaft, and hinders size reduction in the axial direction.

The present disclosure thus aims to provide a linear vibration motor with a magnetic spring mechanism that has achieved size reduction in the axial direction.

A linear vibration motor according to an embodiment of the present disclosure includes: a cylinder having a through-hole with a first open end at a first end in a first direction and a second open end at a second end in the first direction; a mover magnet accommodated in the through-hole of the cylinder and movable between the first open end and the second open end; a first stator magnet disposed closer to the first open end in the first direction than the mover magnet and arranged so as to generate a repulsive magnetic force against the mover magnet; a second stator magnet disposed closer to the second open end in the first direction than the mover magnet and arranged to generate a repulsive magnetic force against the mover magnet; a coil conductor at an outer circumferential surface of the cylinder; and a casing that accommodates the cylinder, the mover magnet, the first stator magnet, the second stator magnet, and the coil conductor, wherein a length A of the cylinder in the first direction, a length B of the casing in the first direction, and a length C of the first stator magnet and the second stator magnet in the first direction satisfy a relationship of A<B<A+2C, wherein the casing includes a side wall extending in the first direction, a first end wall connected to the side wall, and a second end wall connected to the side wall and located opposite to the first end wall, wherein the first end wall, the second end wall, a first portion of the side wall connected to the first end wall and having a predetermined length, and a second portion of the side wall connected to the second end wall and having a predetermined length comprise magnetic bodies, wherein the first stator magnet is attracted to the first end wall with a magnetic force end, and wherein the second stator magnet is attracted to the second end wall with a magnetic force.

A linear vibration motor according to an embodiment of the present disclosure includes: a cylinder having a through-hole with a first open end at a first end in a first direction and a second open end at a second end in the first direction; a mover magnet accommodated in the through-hole of the cylinder and movable between the first open end and the second open end; a first stator magnet disposed closer to the first open end in the first direction than the mover magnet and arranged so as to generate a repulsive magnetic force against the mover magnet; a second stator magnet disposed closer to the second open end in the first direction than the mover magnet and arranged to generate a repulsive magnetic force against the mover magnet; a coil conductor at an outer circumferential surface of the cylinder; and a casing that accommodates the cylinder, the mover magnet, the first stator magnet, the second stator magnet, and the coil conductor, wherein a length A of the cylinder in the first direction, a length B of the casing in the first direction, and a length C of the first stator magnet and the second stator magnet in the first direction satisfy a relationship of A+2C<B, wherein the casing includes a side wall extending in the first direction, a first end wall connected to the side wall, and a second end wall connected to the side wall and located opposite to the first end wall, wherein the first end wall, the second end wall, a first portion of the side wall connected to the first end wall and having a predetermined length, and a second portion of the side wall connected to the second end wall and having a predetermined length comprise magnetic bodies, wherein the first end wall has a first recess that opens toward the first open end, wherein the second end wall has a second recess that opens toward the second open end, wherein the first stator magnet is at least partially accommodated in the first recess, and is attracted to the first end wall with a magnetic force, and wherein the second stator magnet is at least partially accommodated in the second recess, and is attracted to the second end wall with a magnetic force.

In these structures, the first stator magnet and the second stator magnet are securely positioned, relative to the casing, in the positions where the first stator magnet and the second stator magnet can continuously and appropriately provide a magnetic force to allow the mover magnet to move (vibrate) in the through-hole of the cylinder.

The present disclosure can provide a linear vibration motor with a magnetic spring mechanism that has achieved size reduction in an axial direction.

### BRIEF DESCRIPTION OF THE DRAWINGS

FIG. 1(A) is an external perspective view of a linear vibration motor according to a first embodiment, and FIG. 1(B) is an external perspective view of a cylinder according to the first embodiment.

FIG. 2 is an exploded perspective view of a linear vibration motor according to the first embodiment.

FIG. 3(A) and FIG. 3(B) are cross-sectional views of the linear vibration motor according to the first embodiment.

FIG. 4 is a conceptual diagram of magnetic flux loops caused by a stator magnet and a mover magnet.

FIG. 5(A), FIG. 5(B), FIG. 5(C), and FIG. 5(D) are cross-sectional views illustrating the states in processes included in a method for manufacturing the linear vibration motor according to the first embodiment.

FIG. 6(A) and FIG. 6(B) are cross-sectional views illustrating the states in processes included in a method for manufacturing the linear vibration motor according to the first embodiment.

FIG. 7 is a side cross-sectional view of a linear vibration motor according to a second embodiment.

FIG. 8 is a side cross-sectional view of a linear vibration motor according to a third embodiment.

FIG. 9 is a side cross-sectional view of a linear vibration motor according to a fourth embodiment.

FIG. 10(A) and FIG. 10(B) are side cross-sectional views of a linear vibration motor according to a fifth embodiment.

FIG. 11 is a side cross-sectional view of a linear vibration motor according to a sixth embodiment.

FIG. 12 is a cross-sectional view illustrating the state in a process included in a method for manufacturing the linear vibration motor according to the sixth embodiment.

FIG. 13 is a cross-sectional view illustrating the state in a process included in a method for manufacturing the linear vibration motor according to the sixth embodiment.

FIG. 14 is a side cross-sectional view of a linear vibration motor according to a seventh embodiment.

FIG. 15 is a cross-sectional view illustrating the state in a process included in a method for manufacturing the linear vibration motor according to the seventh embodiment.

### DESCRIPTION OF THE PREFERRED EMBODIMENTS

### First Embodiment

A linear vibration motor and a method for manufacturing a linear vibration motor according to a first embodiment of the present disclosure are described with reference to the drawings.

### Structure of Linear Vibration Motor 10

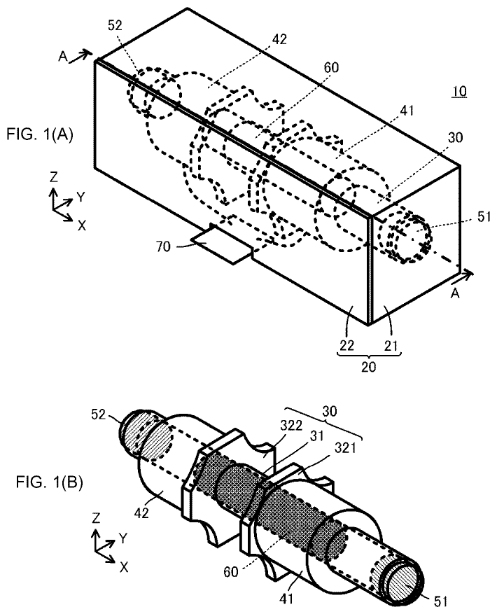

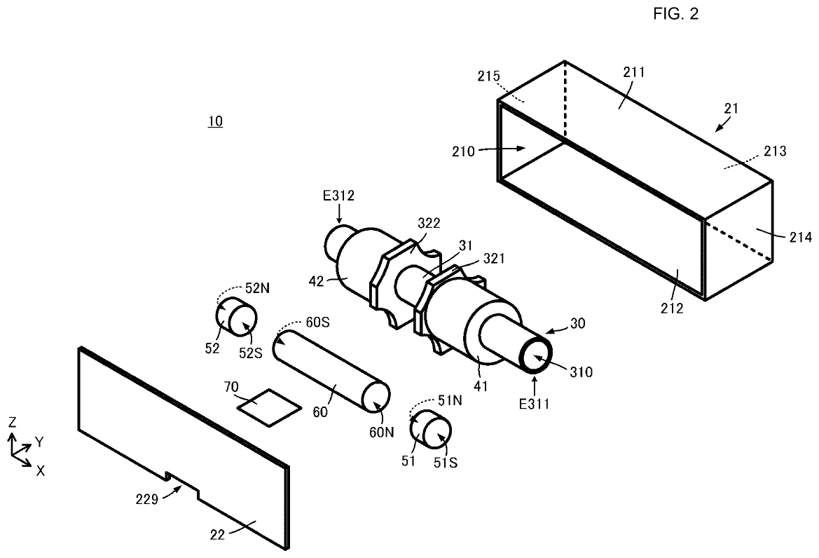

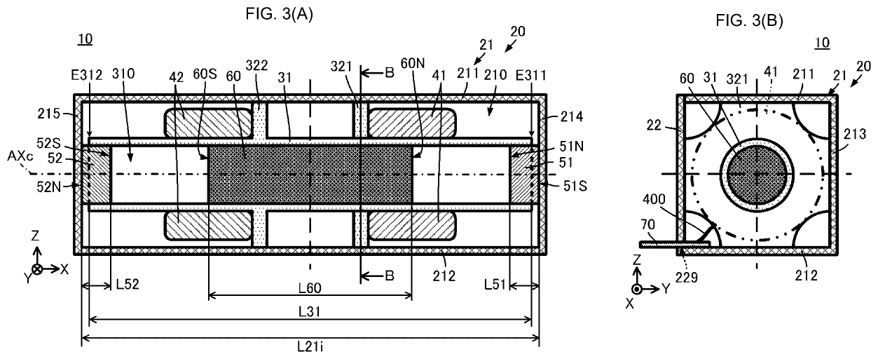

FIG. 1(A) is an external perspective view of a linear vibration motor according to the first embodiment, and FIG. 1(B) is an external perspective view of a cylinder according to the first embodiment. FIG. 2 is an exploded perspective view of the linear vibration motor according to the first embodiment. FIG. 3(A) and FIG. 3(B) are cross-sectional views of the linear vibration motor according to the first embodiment. FIG. 3(A) illustrates a cross section taken along line A-A in FIG. 1(A), and parallel to the longitudinal direction of a linear vibration motor. FIG. 3(B) illustrates a cross section taken along line B-B in FIG. 3(A), and perpendicular to the longitudinal direction of the linear vibration motor.

As illustrated in FIG. 1(A), FIG. 1(B), FIG. 2, FIG. 3(A), and FIG. 3(B), a linear vibration motor 10 includes a casing 20, a cylinder 30, a coil conductor 41, a coil conductor 42, a stator magnet 51, a stator magnet 52, a mover magnet 60, and a flexible wiring board 70.

Either one of the stator magnet 51 and the stator magnet 52 corresponds to a first stator magnet, and the other one corresponds to a second stator magnet. In the description below, the stator magnet 51 corresponds to a first stator magnet, and the stator magnet 52 corresponds to a second stator magnet.

The casing 20 has a rectangular prism shape. The casing 20 is formed from a magnetic body. The casing 20 includes a body 21 and a lid 22.

The body 21 is a box having a rectangular prism shape and having one openable side surface extending in the longitudinal direction (X-axis direction in the drawings). More specifically, the body 21 includes a side wall 211, a side wall 212, a side wall 213, an end wall 214, and an end wall 215, which are formed from flat boards.

The side wall 211, the side wall 212, and the side wall 213 have main surfaces parallel to the longitudinal direction. The main surface of the side wall 213 is perpendicular to the main surface of the side wall 211 and the main surface of the side wall 212. The side wall 213 is connected to the side wall 211 and the side wall 212.

The end wall 214 and the end wall 215 have main surfaces perpendicular to the longitudinal direction. The end wall 214 is connected to first ends of the side wall 211, the side wall 212, and the side wall 213 in the longitudinal direction. The end wall 215 is connected to first ends of the side wall 211, the side wall 212, and the side wall 213 in the longitudinal direction.

The lid 22 is formed from a flat board. The lid 22 has substantially the same shape as the side wall 211, the side wall 212, and the side wall 213. The lid 22 is disposed to close the opening of the body 21. Thus, the casing 20 has a casing interior space 210 with a substantially rectangular prism shape defined by the body 21 and the lid 22.

The lid 22 has an opening 229. The opening 229 allows the casing interior space 210 to be connected to the space outside the casing 20.

The cylinder 30 includes a hollow cylindrical body 31, a flange 321, and a flange 322. The cylinder 30 is formed from a non-magnetic material. The body 31 has a first end portion E311, a second end portion E312, and a through-hole 310 that connects an opening (first open end) in the first end portion E311 and an opening (second open end) in the second end portion E312.

The flange 321 and the flange 322 are formed from substantially polygonal flat boards. The flange 321 and the flange 322 are disposed at an outer circumferential surface of the hollow cylindrical body 31. A flat surface of the flange 321 and a flat surface of the flange 322 are perpendicular to a direction in which the body 31 extends (direction in which the through-hole 310 extends). The flange 321 and the flange 322 are disposed at the body 31 to protrude outward from the outer circumferential surface of the body 31.

The flange 321 and the flange 322 are positioned at portions of the body 31 between the ends in the longitudinal direction. More specifically, the flange 321 and the flange 322 are positioned substantially equidistant from the center of the body 31 in the longitudinal direction toward the first end portion E311 and the second end portion E312.

The flange 321 and the flange 322 are positioned to allow a coil conductor 41 and a coil conductor 42 (described later) to be positioned at predetermined positions (for example, positions at which the coil conductors 41 and 42 do not overlap the stator magnets 51 and 52 in the longitudinal direction) with respect to the body 31.

The length of the flange 321 and the flange 322 in a direction perpendicular to the longitudinal direction (Y-direction in the drawings) is substantially the same as the distance between the side wall 213 and the lid 22 of the casing 20. The length of the flange 321 and the flange 322 in another direction perpendicular to the longitudinal direction (Z-direction in the drawings) is substantially the same as the distance between the side wall 211 and the side wall 212 of the casing 20.

The surfaces of the flange 321 and the flange 322 adjacent to or in contact with the side wall 211, the side wall 212, the side wall 213, and the lid 22 are flat surfaces.

The coil conductor 41 and the coil conductor 42 each have a shape formed by winding a wire conductor into a cylindrical shape. The coil conductor 41 and the coil conductor 42 are disposed along the outer circumferential surface of the body 31 of the cylinder 30. In other words, the body 31 extends through the central hole in the coil conductor 41, and extends through the central hole in the coil conductor 42.

The coil conductor 41 is positioned closer to the first end portion E311 than the flange 321 of the body 31, and is in contact with the flange 321. The coil conductor 42 is positioned closer to the second end portion E312 than the flange 322 of the body 31, and is in contact with the flange 322.

The stator magnet 51, the stator magnet 52, and the mover magnet 60 are formed from ferromagnetic permanent magnets. For example, the stator magnet 51, the stator magnet 52, and the mover magnet 60 are formed from neodymium magnets.

The stator magnet 51, the stator magnet 52, and the mover magnet 60 have solid cylindrical shapes. The height of the stator magnet 51 and the height of the stator magnet 52 are lower than the height of the mover magnet 60.

When viewed in the respective height directions, the shapes of the stator magnet 51, the stator magnet 52, and the mover magnet 60 are substantially the same as the shape of the through-hole 310 of the body 31 of the cylinder 30 when viewed in the axial direction. When viewed in the respective height directions, the stator magnet 51, the stator magnet 52, and the mover magnet 60 have such sizes as to be accommodated in the through-hole 310.

The mover magnet 60 is accommodated in the through-hole 310 of the cylinder 30. The mover magnet 60 is accommodated while being movable between the first end portion E311 (first open end) and the second end portion E312 (second open end).

The stator magnet 51 is positioned to overlap the first end portion E311 in the longitudinal direction of the body 31 of the cylinder 30 while having a part in the height direction accommodated in the through-hole 310.

The stator magnet 52 is positioned to overlap the second end portion E312 in the longitudinal direction of the body 31 of the cylinder 30 while having a part in the height direction accommodated in the through-hole 310.

The stator magnet 51 and the mover magnet 60 are disposed while having the same magnetic poles facing each other. The stator magnet 52 and the mover magnet 60 are disposed while having the same magnetic poles facing each other.

For example, more specifically, as illustrated in FIG. 2 and FIG. 3(A), the mover magnet 60 is disposed while having an N-pole surface 60N facing the first end portion E311 and while having an S-pole surface 60S facing the second end portion E312.

The stator magnet 51 is disposed while having an N-pole surface 51N facing the mover magnet 60, and while having an S-pole surface 51S facing outward in the longitudinal direction from the first end portion E311 of the body 31. The stator magnet 51 is thus disposed to generate a repulsive force caused by a magnetic force against the mover magnet 60.

The stator magnet 52 is disposed while having an S-pole surface 52S facing the mover magnet 60, and while having an N-pole surface 52N facing outward in the longitudinal direction from the second end portion E312 of the body 31. The stator magnet 52 is thus disposed to generate a repulsive force caused by a magnetic force against the mover magnet 60.

The flexible wiring board 70 includes a conductor pattern, and is connected to the coil conductor 41 and the coil conductor 42 through wires 400. The wires 400 are formed from leading end portions of the coil conductor 41 and the coil conductor 42.

The cylinder 30 that accommodates the mover magnet 60 and on which the multiple coil conductors 41 and 42 are disposed, the stator magnet 51, the stator magnet 52, and the flexible wiring board 70 are accommodated in the casing interior space 210 of the casing 20. The direction in which the cylinder 30 extends is parallel to the longitudinal direction of the casing 20. The direction in which the cylinder 30 extends corresponds to the longitudinal direction of the cylinder 30, and a direction in which the first end portion E311 and the second end portion E312 in the cylinder 30 are connected.

The cylinder 30 is positioned while having the center in the direction in which the cylinder 30 extends substantially aligned with the center of the casing 20 in the longitudinal direction.

The stator magnet 51 is disposed while having the S-pole surface 51S in contact with the inner wall surface of the end wall 214 of the casing 20. A part of the stator magnet 51 located closer to the N-pole surface 51N in the height direction is accommodated in the through-hole 310 of the body 31 of the cylinder 30.

The stator magnet 52 is disposed while having the N-pole surface 52N in contact with the inner wall surface of the end wall 215 of the casing 20. A part of the stator magnet 52 located closer to the S-pole surface 52S in the height direction is accommodated in the through-hole 310 of the body 31 of the cylinder 30.

The flexible wiring board 70 extends through the opening 229 of the lid 22 while having a part of the flexible wiring board 70 disposed in the casing interior space 210 and another part of the flexible wiring board 70 disposed outside the casing 20.

In such a structure, an alternating-current driving signal is applied to the coil conductor 41 and the coil conductor 42. Thus, the coil conductor 41 and the coil conductor 42 excite an electromagnetic field. This electromagnetic field acts on the mover magnet 60, and moves the mover magnet 60 in the longitudinal direction of the cylinder 30.

At this time, the mover magnet 60 receives a repulsive force caused by a magnetic force from the stator magnet 51 and the stator magnet 52 at both ends in the longitudinal direction. The mover magnet 60 thus vibrates in the longitudinal direction. The linear vibration motor 10 can thus generate vibrations with a magnetic spring mechanism.

With the propagation of the vibrations to the casing 20, the linear vibration motor 10 can provide vibrations to an object or a person that is in contact with the casing 20.

In this structure, the casing 20 is formed from a magnetic body, and the stator magnet 51 is thus attracted to the end wall 214 with a magnetic force. The stator magnet 52 is fixed to the end wall 215 with a magnetic force.

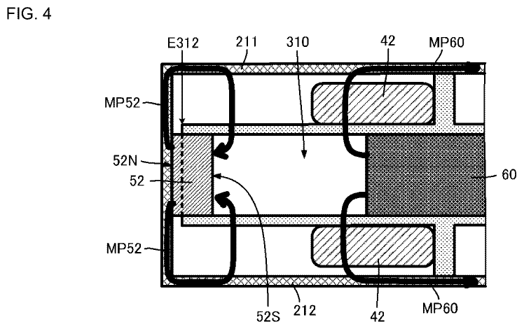

More specifically, FIG. 4 is a conceptual diagram of magnetic flux loops caused by a stator magnet and the mover magnet. Although FIG. 4 illustrates the stator magnet 52 as an example, the stator magnet 51 can also generate similar magnetic flux loops.

As illustrated in FIG. 4, the magnetic field (line of magnetic force) starting from the stator magnet 52 extends through the end wall 215 of the casing 20 formed from a closest magnetic body, and through the side wall 211, the side wall 212, the side wall 213 (not illustrated), and the lid 22 (not illustrated), and returns to the stator magnet 52.

At this time, the mover magnet 60 is located near the center of the casing 20 in the longitudinal direction. The stator magnet 52 and the mover magnet 60 have a relationship of generating repulsive magnetic forces against each other. The magnetic field generated by the stator magnet 52 is thus less likely to leak toward the mover magnet 60, and is confined around the stator magnet 52.

The magnetic flux loop of the stator magnet 52 thus connects the end wall 215 of the casing 20 and portions of the side wall 211, the side wall 212, the side wall 213 (not illustrated), and the lid 22 (not illustrated) connected to the end wall 215 by a predetermined length. The stator magnet 52 is thus attracted to the end wall 215 that comes into surface contact with the stator magnet 52.

The stator magnet 51 is similarly attracted to the end wall 214 that comes into surface contact with the stator magnet 51.

The stator magnet 51 and the stator magnet 52 are thus securely fixed to the casing 20 in positions at which the stator magnet 51 and the stator magnet 52 can continuously and appropriately provide a magnetic force to allow the mover magnet 60 to move (vibrate) in the through-hole 310 of the cylinder 30. This structure does not involve the use of other components that greatly increase the shape for positioning the stator magnet 51 and the stator magnet 52, and the linear vibration motor 10 thus enables size reduction. The stator magnet 51 and the stator magnet 52 can be fixed to the casing 20 without an adhesive. The linear vibration motor 10 with a magnetic spring mechanism can thus be easily manufactured.

As illustrated in FIG. 3(A), when the longitudinal direction of the casing 20 and the direction in which the cylinder 30 extends are defined as a first direction, a length L31 (length A in the first direction) of the cylinder 30 in the first direction, a length L21i of the casing 20 in the first direction (length B in the first direction), a length L51 of the stator magnet 51 in the first direction (length C in the first direction), and a length L52 of the stator magnet 52 in the first direction (length C in the first direction) satisfy the relationship described below. The length L21i of the casing 20 is a distance between the inner wall surface of the end wall 214 and the inner wall surface of the end wall 215.

$$L 31 < L 21 i < ( L 31 + L 51 + L 52 )$$

More specifically, the length L21i of the casing 20 is longer than the length L31 of the cylinder 30. The length L21i of the casing 20 is shorter than the total length of the length L31 of the cylinder 30, the length L51 of the stator magnet 51, and the length L52 of the stator magnet 52.

When the length L51 and the length L52 are the same and each defined as a length L50, the relationship of L31 <L21i<(L31+2L50) is satisfied. This relationship corresponds to A<B<A+2C herein.

With this relationship, the stator magnet 51 is accommodated in a part of the cylinder 30 located closer to the first end portion E311 and having a predetermined length in the state where the center of the casing 20 in the longitudinal direction is substantially aligned with the center in the direction in which the cylinder 30 extends. Similarly, the stator magnet 52 is accommodated in a part of the cylinder 30 located closer to the second end portion E312 and having a predetermined length.

Thus, the stator magnet 51 and the stator magnet 52 can be more securely positioned in a plane (YZ plane in the drawing) perpendicular to the longitudinal direction. The linear vibration motor 10 with a magnetic spring mechanism capable of more stably positioning the stator magnet 51 and the stator magnet 52 can be easily manufactured.

More preferably, the linear vibration motor 10 satisfies L31<L21i<(L31+L50). In this structure, regardless of when the cylinder 30 moves in the longitudinal direction of the casing 20, the stator magnet 51 and the stator magnet 52 are always positioned within the through-hole 310 of the cylinder 30. Thus, the linear vibration motor 10 can more securely and stably position the stator magnet 51 and the stator magnet 52.

As illustrated in FIG. 3(B), in the linear vibration motor 10, the outer surfaces (peripheral surfaces) of the flange 321 and the outer surfaces (peripheral surfaces) of the flange 322 of the cylinder 30 are in surface contact with the inner wall surfaces of the multiple side walls 211, 212, and 213 and the lid 22 of the casing 20. This structure can reduce rotation of the cylinder 30 about an axis corresponding to the direction in which the cylinder 30 extends.

### Method for Manufacturing Linear Vibration Motor 10

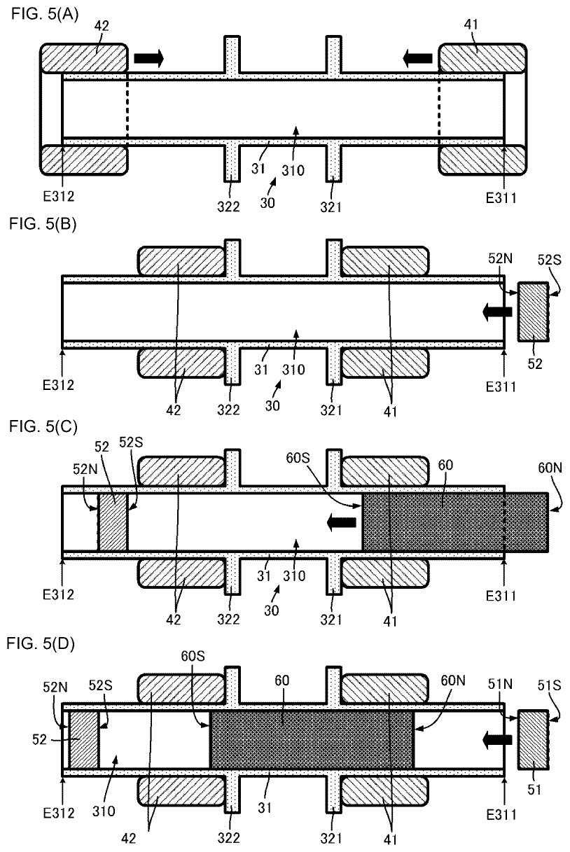

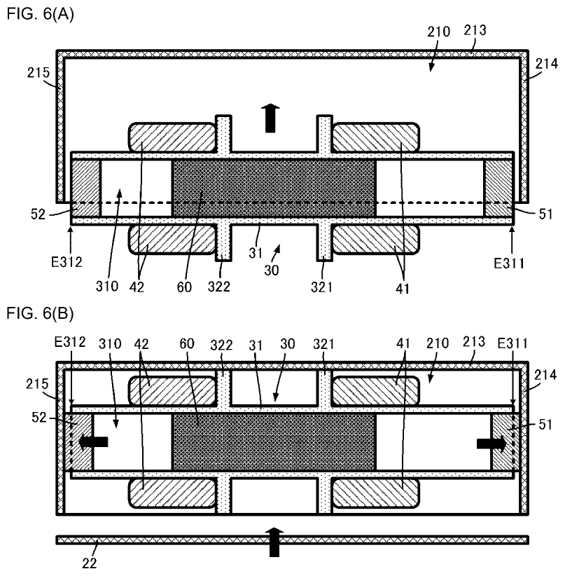

FIG. 5(A), FIG. 5(B), FIG. 5(C), FIG. 5(D), FIG. 6(A), and FIG. 6(B) are cross-sectional views illustrating the states of processes in the method for manufacturing the linear vibration motor according to the first embodiment.

First, the cylinder 30 having the through-hole 310, and including the flange 321 and the flange 322 at the outer circumferential surface is prepared.

Thereafter, as illustrated in FIG. 5(A), the coil conductor 41 is moved along the outer circumferential surface of the cylinder 30 (body 31) from the first end portion E311 of the cylinder 30. The coil conductor 42 is also moved along the outer circumferential surface of the cylinder 30 (body 31) from the second end portion E312 of the cylinder 30. The coil conductor 41 is brought into contact with the flange 321, and the coil conductor 41 is positioned with respect to the cylinder 30. The coil conductor 42 is brought into contact with the flange 322, and the coil conductor 42 is positioned with respect to the cylinder 30.

As illustrated in FIG. 5(B), FIG. 5(C), and FIG. 5(D), the stator magnet 52, the mover magnet 60, and the stator magnet 51 are inserted into the through-hole 310 in this order from the opening of the second end (first end portion E311) while closing the opening of the first end (second end portion E312) of the through-hole 310 in the body 31 of the cylinder 30. At this time, the stator magnet 52, the mover magnet 60, and the stator magnet 51 are inserted in order of the first stator magnet, the mover magnet, and the second stator magnet with magnetic poles of the stator magnet 52, the mover magnet 60, and the stator magnet 51 arranged to cause the mover magnet 60 to repel the stator magnet 51 and the stator magnet 52, more specifically, to cause the stator magnet 52, the mover magnet 60, and the stator magnet 51 to generate repulsive magnetic forces against one another.

As illustrated in FIG. 6(A), the coil conductor 41 and the coil conductor 42 are then positioned, and the cylinder 30 into which the stator magnet 52, the mover magnet 60, and the stator magnet 51 are inserted is inserted, through an opening, into the casing 20 formed from a magnetic body, having a rectangular prism shape, and having one side surface in the longitudinal direction open.

The cylinder 30 is inserted until the flange 321 and the flange 322 come into contact with the side wall 213.

When the cylinder 30 is inserted into the casing 20, the stator magnet 51 is attracted to the end wall 214 with a magnetic force, and the stator magnet 52 is attracted to the end wall 215 with a magnetic force (refer to FIG. 6(B)).

Subsequently, end portions of the coil conductor 41 and the coil conductor 42 are pulled out from the opening of the casing 20 using the flexible wiring board 70 (not illustrated), and the opening is sealed with the lid 22 formed from a magnetic body, as illustrated in FIG. 6(B).

With the above manufacturing method, the linear vibration motor 10 can be easily manufactured without using an adhesive for fixing the stator magnet 51 and the stator magnet 52.

### Second Embodiment

A linear vibration motor and a method for manufacturing a linear vibration motor according to a second embodiment of the present disclosure are described with reference to the drawings.

### Structure of Linear Vibration Motor 10A

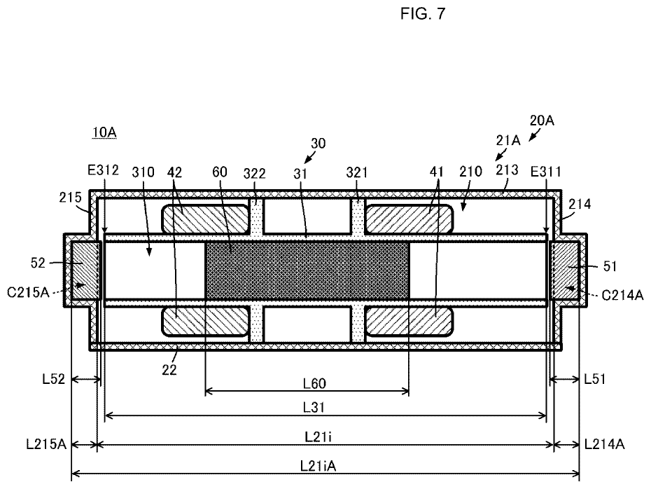

FIG. 7 is a side cross-sectional view of a linear vibration motor according to a second embodiment. As illustrated in FIG. 7, a linear vibration motor 10A according to the second embodiment differs from the linear vibration motor 10 according to the first embodiment in the structure of a casing 20A and a positional relationship between the cylinder 30 and each of the stator magnet 51 and the stator magnet 52. Other components in the linear vibration motor 10A are the same as those in the linear vibration motor 10, and the same components are not described.

The casing 20A includes a body 21A and a lid 22. The body 21A differs from the body 21 of the casing 20 in the first embodiment in that it includes a recess C214A and a recess C215A.

The recess C214A is formed in the end wall 214. The recess C214A is recessed outward from the casing 20A. The recess C214A is positioned to face the opening of the first end portion E311 of the cylinder 30.

The recess C215A is formed in the end wall 215. The recess C215A is recessed outward from the casing 20A. The recess C215A is positioned to face the opening of the second end portion E312 of the cylinder 30.

The stator magnet 51 is accommodated in the recess C214A. The stator magnet 51 does not enter the through-hole 310 of the cylinder 30.

The stator magnet 52 is accommodated in the recess C215A. The stator magnet 52 does not enter the through-hole 310 of the cylinder 30.

In this structure, when the longitudinal direction of the casing 20A and the direction in which the cylinder 30 extends are defined as a first direction, the length L31 of the cylinder 30 in the first direction (length A in the first direction), the length L21i of the casing 20A in the first direction (length B in the first direction), the length L51 of the stator magnet 51 in the first direction (length C in the first direction), and the length L52 of the stator magnet 52 in the first direction (length C in the first direction) satisfy the relationship described below. The length L21i of the casing 20A is a distance between the inner wall surface of the end wall 214 at which the recess C214A is not formed and the inner wall surface of the end wall 215 at which the recess C215A is not formed.

$$( L 31 + L 51 + L 52 ) < L 21 i$$

When the length L51 and the length L52 are the same and each defined as a length L50, the relationship of (L31+2L50)<L21i is satisfied. This relationship corresponds to A+2C<B herein.

With this relationship, the stator magnet 51 is accommodated in the recess C214A (first recess), and is attracted to the end wall 214 with a magnetic force. The stator magnet 52 is accommodated in the recess C215A (second recess), and is attracted to the end wall 215 with a magnetic force.

Thus, the linear vibration motor 10AC with a magnetic spring mechanism capable of more stably positioning the stator magnet 51 and the stator magnet 52 can be easily manufactured.

The linear vibration motor 10A can thus exert the same effects as the linear vibration motor 10.

### Third Embodiment

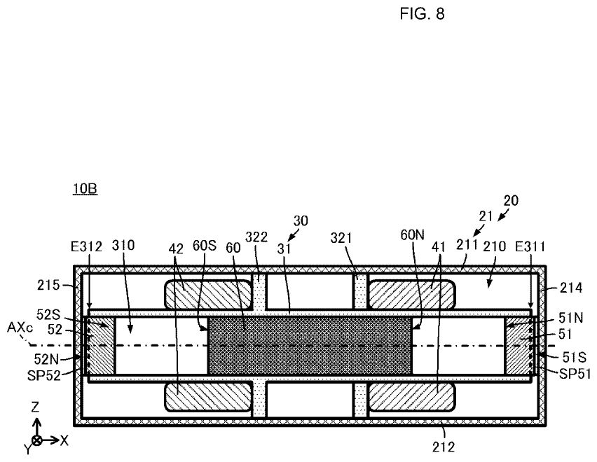

A linear vibration motor according to a third embodiment of the present disclosure is described with reference to the drawings. FIG. 8 is a side cross-sectional view of the linear vibration motor according to the third embodiment.

As illustrated in FIG. 8, a linear vibration motor 10B according to a third embodiment differs from the linear vibration motor 10 according to the first embodiment in that it additionally includes a spacer SP51 and a spacer SP52.

The spacer SP51 and the spacer SP52 have a flat shape, and formed from magnetic bodies. The spacer SP51 is disposed between the stator magnet 51 and the inner wall surface of the end wall 214, and is in contact with the stator magnet 51 and the inner wall surface of the end wall 214. The spacer SP52 is disposed between the stator magnet 52 and the inner wall surface of the end wall 215, and is in contact with the stator magnet 52 and the inner wall surface of the end wall 215.

With the structure including the spacers SP51 and SP52 formed from the magnetic bodies, the linear vibration motor 10B can exert the same effects as the linear vibration motor 10. The linear vibration motor 10B can adjust the positions of the stator magnet 51 and the stator magnet 52 relative to the mover magnet 60 in a direction parallel to the vibration direction of the mover magnet 60 using the spacers SP51 and SP52.

The linear vibration motor 10B can exert the same effects as the linear vibration motor 10.

### Fourth Embodiment

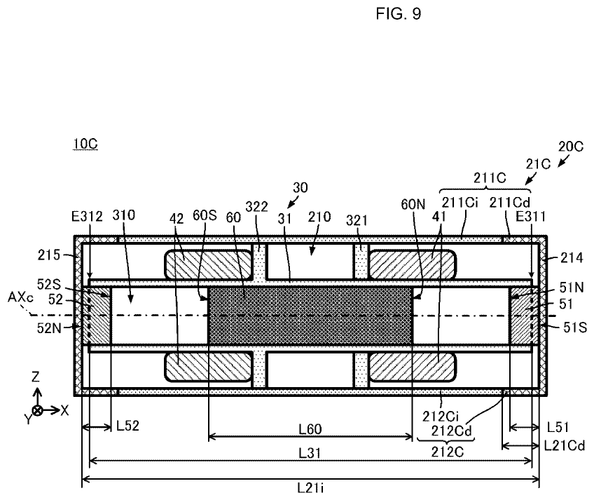

A linear vibration motor according to a fourth embodiment of the present disclosure is described with reference to the drawings. FIG. 9 is a side cross-sectional view of a linear vibration motor according to a fourth embodiment.

As illustrated in FIG. 9, a linear vibration motor 10C according to a fourth embodiment differs from the linear vibration motor 10 according to the first embodiment in the structure of a casing 20F. Other components in the linear vibration motor 10C are the same as those in the linear vibration motor 10, and the same components are not described.

A casing 20C includes a body 21C. The body 21C includes a side wall 211C, a side wall 212C, and a side wall 213C (not illustrated).

The side wall 211C includes magnetic portions 211Cd and a non-magnetic portion 211Ci. The magnetic portions 211Cd are positioned at end portions of the side wall 211C connected to the end wall 214 and the end wall 215, and the non-magnetic portion 211Ci is positioned between the magnetic portions 211Cd at both ends. The magnetic portions 211Cd correspond to “a first portion” and “a second portion” in the present disclosure, and the non-magnetic portion 211Ci corresponds to “a third portion” in the present disclosure.

The side wall 212C includes magnetic portions 212Cd and a non-magnetic portion 212Ci. The magnetic portions 212Cd are positioned at end portions of the side wall 212C connected to the end wall 214 and the end wall 215, and the non-magnetic portion 212Ci is positioned between the magnetic portions 212Cd at both ends.

Although not illustrated, the side wall 213C and the lid 22 also have the same structure as the side wall 211C and the side wall 212C.

Preferably, a length L21Cd, in the first direction, of the magnetic portion 211Cd and the magnetic portion 212Cd at one end portion is greater than or equal to the length L51 of the stator magnet 51 and the length L52 of the stator magnet 52 (L21Cd≥L51 and L52, greater than or equal to the length C herein).

With this structure, the linear vibration motor 10C can exert the same effects as the linear vibration motor 10.

As in the linear vibration motor 10C according to the fourth embodiment, when a structure in which the casing 20A includes the recess C214A and the recess C215A is applied to the structure in which the non-magnetic portion 211Ci is used as the casing 20C, as in the linear vibration motor 10A according to the second embodiment, the dimensions described below are preferable. The length L21Cd, in the first direction, of the magnetic portion 211Cd and the magnetic portion 212Cd at one end portion is greater than or equal to a value obtained by subtracting a depth L214A of the recess C214A from the length L51 of the stator magnet 51 (corresponding to a value greater than or equal to (C-D) herein), and greater than or equal to a value obtained by subtracting a depth L215C of the recess C215C from the length L52 of the stator magnet 52 (corresponding to a value greater than or equal to (C-D) herein).

The linear vibration motor 10C can thus exert the same effects as the linear vibration motor 10.

### Fifth Embodiment

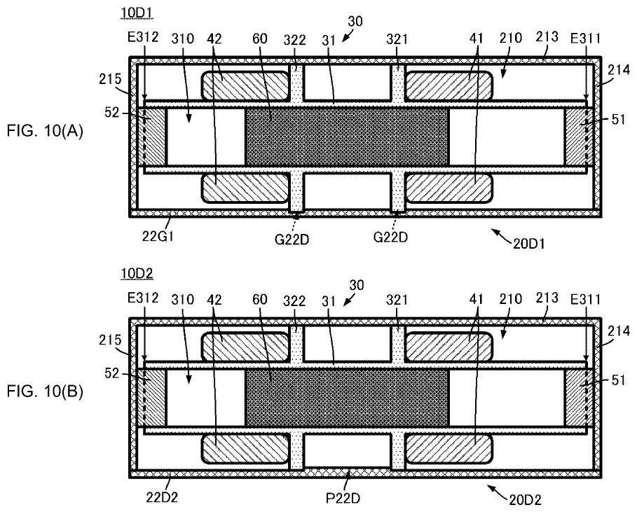

A linear vibration motor according to a fifth embodiment of the present disclosure is described with reference to the drawings. FIG. 10(A) and FIG. 10(B) are side cross-sectional views of a linear vibration motor according to a fifth embodiment.

As illustrated in FIG. 10(A), a linear vibration motor 10D1 according to a fifth embodiment differs from the linear vibration motor 10 according to the first embodiment in the structure of a lid 22G1. As illustrated in FIG. 10(B), a linear vibration motor 10D2 according to a fifth embodiment differs from the linear vibration motor 10 according to the first embodiment in the structure of a lid 22D2. Other components in the linear vibration motor 10D1 and the linear vibration motor 10D2 are the same as those in the linear vibration motor 10, and the same components are not described.

As illustrated in FIG. 10(A), a lid 22D1 includes grooves G22D in which the flange 321 and the flange 322 of the body 31 of the cylinder 30 are accommodated or fitted. When the flange 321 and the flange 322 are accommodated or fitted in the grooves G22D, the position of the body 31 of the cylinder 30 relative to a casing 20D1 in the vibration direction of the mover magnet 60 is fixed.

As illustrated in FIG. 10(B), the lid 22D2 includes a protrusion P22D held between the flange 321 and the flange 322 of the body 31 of the cylinder 30. When the flange 321 and the flange 322 hold the protrusion P22D therebetween, the position of the body 31 of the cylinder 30 relative to a casing 20D2 in the vibration direction of the mover magnet 60 is fixed.

With these structures, the linear vibration motor 10D1 and the linear vibration motor 10D2 can more effectively generate vibrations while exerting the same effects as the linear vibration motor 10.

In the present disclosure, the lid includes grooves or a protrusion, but the side wall of the body of the casing may instead include grooves or a protrusion.

### Sixth Embodiment

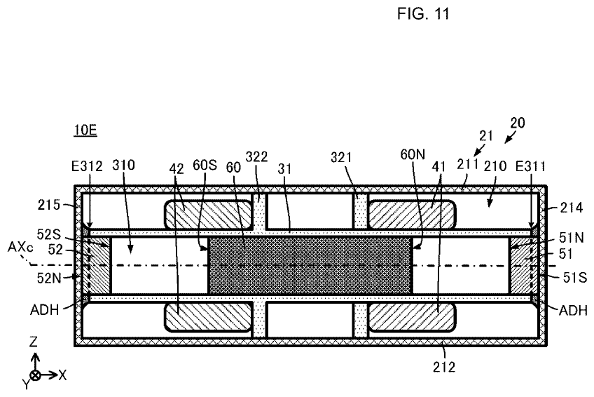

A linear vibration motor according to a sixth embodiment of the present disclosure is described with reference to the drawings. FIG. 11 is a side cross-sectional view of a linear vibration motor according to a sixth embodiment.

As illustrated in FIG. 11, a linear vibration motor 10E according to a sixth embodiment differs from the linear vibration motor 10 according to the first embodiment in that it includes an adhesive ADH. Other components in the linear vibration motor 10E are the same as those in the linear vibration motor 10, and the same components are not described.

In the linear vibration motor 10E, the stator magnet 51 is bonded and fixed to the end wall 214 with the adhesive ADH. The stator magnet 52 is bonded and fixed to the end wall 215 with the adhesive ADH. The adhesive ADH may be used to bond the cylinder 30.

### Method for Manufacturing Linear Vibration Motor 10E

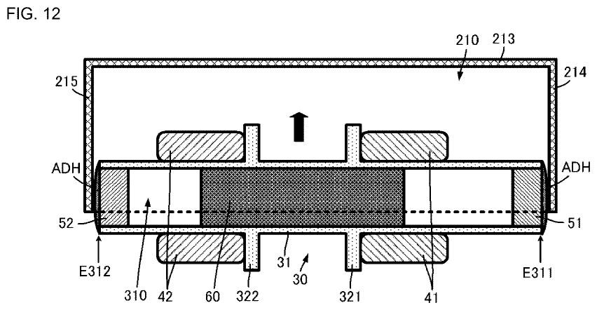

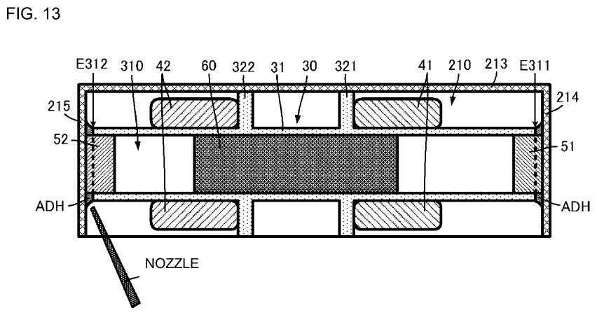

FIG. 12 and FIG. 13 are cross-sectional views illustrating the states in processes included in methods for manufacturing the linear vibration motor according to the sixth embodiment. The manufacturing method illustrated in FIG. 12 and the manufacturing method illustrated in FIG. 13 are different methods.

In the manufacturing method illustrated in FIG. 12, the adhesive ADH is applied to the first end portion E311 and the second end portion E312 of the cylinder 30 while the stator magnet 51 and the stator magnet 52 are inserted into the cylinder 30. At this time, the adhesive ADH is uncured.

When the cylinder 30 to which the adhesive ADH is applied is inserted in this manner, as described in the first embodiment, the cylinder 30 is positioned at a predetermined position of the casing 20. Thereafter, the stator magnet 51 is attracted to the end wall 214 with a magnetic force, and the stator magnet 52 is attracted to the end wall 215 with a magnetic force. The adhesive ADH is applied to the first end portion E311 and the second end portion E312 of the cylinder 30, and thus the adhesive ADH adheres to the stator magnet 51 and the end wall 214, and adheres to the stator magnet 52 and the end wall 215. After the adhesive ADH is cured, the stator magnet 51 is bonded to the end wall 214, and the stator magnet 52 is bonded to the end wall 215.

With the manufacturing method illustrated in FIG. 13, first, the cylinder 30 is positioned at a predetermined position of the casing 20, the stator magnet 51 is attracted to the end wall 214, and the stator magnet 52 is attracted to the end wall 215. In this state, the adhesive ADH is applied to the positions of the stator magnet 51 and the stator magnet 52 using a nozzle. After the adhesive ADH is cured, the stator magnet 51 is bonded to the end wall 214, and the stator magnet 52 is bonded to the end wall 215.

With this structure, the linear vibration motor 10E can exert the same effects as the linear vibration motor 10.

### Seventh Embodiment

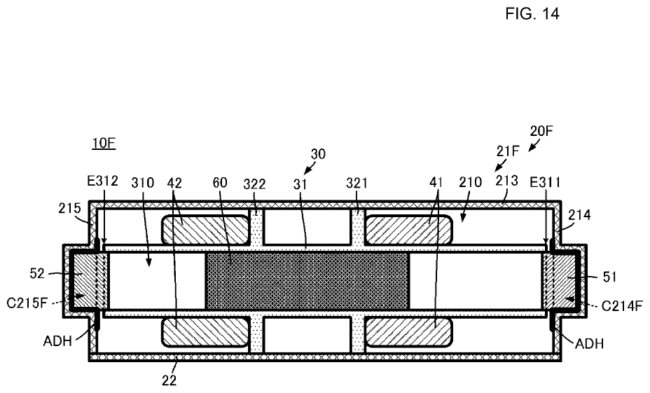

A linear vibration motor according to a seventh embodiment of the present disclosure is described with reference to the drawings. FIG. 14 is a side cross-sectional view of a linear vibration motor according to a seventh embodiment.

As illustrated in FIG. 14, a linear vibration motor 10F according to a seventh embodiment differs from the linear vibration motor 10A according to the second embodiment in that it includes an adhesive ADH. Other components in the linear vibration motor 10F are the same as those in the linear vibration motor 10A, and the same components are not described.

The linear vibration motor 10F includes an adhesive ADH on at least the wall surface of a recess C214F and the wall surface of a recess C215F in the casing 20F.

The stator magnet 51 is accommodated in the recess C214F, and is bonded and fixed to the wall surface of the recess C214F with the adhesive ADH.

The stator magnet 52 is accommodated in the recess C215F, and is bonded and fixed to the wall surface of the recess C215F with the adhesive ADH.

### Method for Manufacturing Linear Vibration Motor 10F

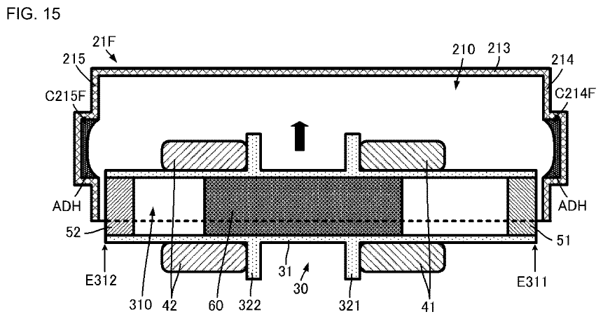

FIG. 15 is a cross-sectional view illustrating the state in a process included in the method for manufacturing of the linear vibration motor according to the seventh embodiment.

In the manufacturing method illustrated in FIG. 15, the adhesive ADH is applied to the recess C214F and the recess C215F in a body 21F of the casing 20F. At this time, the adhesive ADH is uncured.

The cylinder 30 into which the stator magnet 51 and the stator magnet 52 are inserted is then inserted into the body 21F.

When the cylinder 30 reaches a position at which it overlaps the recess C214F and the recess C215F, the stator magnet 51 is drawn into the recess C214F, and accommodated in the recess C214F to which the adhesive ADH is applied. Similarly, the stator magnet 52 is drawn into the recess C215F, and accommodated in the recess C215F to which the adhesive ADH is applied.

After the adhesive ADH is cured, the stator magnet 51 is bonded to the end wall 214 in the recess C214F, and the stator magnet 52 is bonded to the end wall 215 in the recess C215F.

With this structure, the linear vibration motor 10F can exert the same effects as the linear vibration motor 10.

As illustrated in FIG. 14, in the linear vibration motor 10F, the stator magnet 51 and the stator magnet 52 are fixed with the adhesive ADH, and parts of the stator magnet 51 and the stator magnet 52 enter the through-hole 310 of the cylinder 30. Thus, the stator magnet 51 and the stator magnet 52 are more securely fixed in appropriate positions.

### REFERENCE SIGNS LIST

10, 10A, 10B, 10C, 10D, 10E, 10F linear vibration motor
20, 20A, 20C, 20D, 20F casing
21, 21A, 21C, 21F body
22, 22A lid
30 cylinder
31 body
41, 42 coil conductor
51, 52 stator magnet
60 mover magnet
51N, 52N, 60N N-pole surface
51S, 52S, 60S S-pole surface
70 flexible wiring board
210 casing interior space
211, 212, 213 side wall
214, 215 end wall
229 opening
310 through-hole
400 wire
C214A, C214F, C215A, C215F, C22B recess
E311 first end portion
E312 second end portion
F214, F215 receiving wall

1. A linear vibration motor, comprising:
a cylinder having a through-hole with a first open end at a first end in a first direction and a second open end at a second end in the first direction;
a mover magnet accommodated in the through-hole of the cylinder and movable between the first open end and the second open end;
a first stator magnet disposed closer to the first open end in the first direction than the mover magnet and arranged so as to generate a repulsive magnetic force against the mover magnet;
a second stator magnet disposed closer to the second open end in the first direction than the mover magnet and arranged to generate a repulsive magnetic force against the mover magnet;
a coil conductor at an outer circumferential surface of the cylinder; and
a casing that accommodates the cylinder, the mover magnet, the first stator magnet, the second stator magnet, and the coil conductor,
wherein a length A of the cylinder in the first direction, a length B of the casing in the first direction, and a length C of the first stator magnet and the second stator magnet in the first direction satisfy a relationship of A<B<A+2C,
wherein the casing includes a side wall extending in the first direction, a first end wall connected to the side wall, and a second end wall connected to the side wall and located opposite to the first end wall,
wherein the first end wall, the second end wall, a first portion of the side wall connected to the first end wall and having a predetermined length, and a second portion of the side wall connected to the second end wall and having a predetermined length comprise magnetic bodies,
wherein the first stator magnet is attracted to the first end wall with a magnetic force end, and
wherein the second stator magnet is attracted to the second end wall with a magnetic force.

2. The linear vibration motor according to claim 1,
wherein a length A of the cylinder in the first direction, a length B of the casing in the first direction, and a length C of the first stator magnet and the second stator magnet in the first direction satisfy a relationship of A<B<A+C.

3. The linear vibration motor according to claim 1,
wherein the casing includes a third portion between the first portion and the second portion of the side wall, and connected to the first portion and the second portion,
wherein the third portion comprises a non-magnetic body, and
wherein a length of the first portion and the second portion in the first direction is greater than or equal to the length C.

4. The linear vibration motor according to claim 1,
wherein the first end wall includes a first recess that opens toward the first open end and faces the first open end,
wherein the second end wall includes a second recess that opens toward the second open end and faces the second open end,
wherein the first stator magnet is accommodated in the first recess, and
wherein the second stator magnet is accommodated in the second recess.

5. The linear vibration motor according to claim 4, further comprising an adhesive that fixes the first stator magnet and the second stator magnet to the casing.

6. The linear vibration motor according to claim 1,
wherein the casing has a rectangular prism shape,
wherein the cylinder includes a flange constructed to position the coil conductor in the casing,
wherein the flange has a polygonal shape when viewed in the first direction, and
the side wall of the casing and the polygonal outer surface of the flange are in surface contact with each other.

7. The linear vibration motor according to claim 1, further comprising an adhesive that fixes the first stator magnet and the second stator magnet to the casing.

8. The linear vibration motor according to claim 6, wherein a lid of the casing includes grooves that accommodate the flange of the cylinder.

9. The linear vibration motor according to claim 6, wherein a lid of the casing includes a protrusion that abuts the flange of the cylinder.

10. A linear vibration motor, comprising:
a cylinder having a through-hole with a first open end at a first end in a first direction and a second open end at a second end in the first direction;
a mover magnet accommodated in the through-hole of the cylinder and movable between the first open end and the second open end;
a first stator magnet disposed closer to the first open end in the first direction than the mover magnet and arranged so as to generate a repulsive magnetic force against the mover magnet;
a second stator magnet disposed closer to the second open end in the first direction than the mover magnet and arranged to generate a repulsive magnetic force against the mover magnet;
a coil conductor at an outer circumferential surface of the cylinder; and
a casing that accommodates the cylinder, the mover magnet, the first stator magnet, the second stator magnet, and the coil conductor,
wherein a length A of the cylinder in the first direction, a length B of the casing in the first direction, and a length C of the first stator magnet and the second stator magnet in the first direction satisfy a relationship of A+2C<B,
wherein the casing includes a side wall extending in the first direction, a first end wall connected to the side wall, and a second end wall connected to the side wall and located opposite to the first end wall,
wherein the first end wall, the second end wall, a first portion of the side wall connected to the first end wall and having a predetermined length, and a second portion of the side wall connected to the second end wall and having a predetermined length comprise magnetic bodies,
wherein the first end wall has a first recess that opens toward the first open end,
wherein the second end wall has a second recess that opens toward the second open end,
wherein the first stator magnet is at least partially accommodated in the first recess, and is attracted to the first end wall with a magnetic force, and
wherein the second stator magnet is at least partially accommodated in the second recess, and is attracted to the second end wall with a magnetic force.

11. The linear vibration motor according to claim 10,
wherein the casing includes a third portion between the first portion and the second portion of the side wall, and connected to the first portion and the second portion,
wherein the third portion comprises a non-magnetic body, and
wherein a length of the first portion and the second portion in the first direction is greater than or equal to a value (C-D) obtained by subtracting a depth D of the first recess and the second recess from the length C.

12. The linear vibration motor according to claim 10,
wherein the casing has a rectangular prism shape,
wherein the cylinder includes a flange constructed to position the coil conductor in the casing,
wherein the flange has a polygonal shape when viewed in the first direction, and
the side wall of the casing and the polygonal outer surface of the flange are in surface contact with each other.

13. The linear vibration motor according to claim 10, further comprising an adhesive that fixes the first stator magnet and the second stator magnet to the casing.

14. The linear vibration motor according to claim 12, wherein a lid of the casing includes grooves that accommodate the flange of the cylinder.

15. The linear vibration motor according to claim 12, wherein a lid of the casing includes a protrusion that abuts the flange of the cylinder.

16. A method for manufacturing a linear vibration motor, the method comprising:
preparing a cylinder having a through-hole, and including a polygonal flange at an outer circumferential surface thereof;
placing a coil conductor on the outer circumferential surface of the cylinder and positioning the coil conductor with the flange;
inserting the first stator magnet, the mover magnet, and the second stator magnet into the through-hole such that magnetic poles of the first stator magnet, the mover magnet, and the second stator magnet arranged to cause the mover magnet to repel the first stator magnet and the second stator magnet;
inserting the cylinder having the coil conductor, the first stator magnet, the mover magnet, and the second stator magnet into a casing comprising a magnetic body, having a rectangular prism shape, and having one of side surfaces extending in a longitudinal direction open such that the polygonal flange is brought into contact with an inner wall surface of the casing to restrict rotation of the cylinder inside the casing; and
drawing out an end portion of the coil conductor from the opening of the casing and sealing the opening with a lid comprising a magnetic body,
wherein a length A of the cylinder in a longitudinal direction, a length B of the casing in the longitudinal direction, and a length C of the first stator magnet and the second stator magnet in the longitudinal direction satisfy a relationship of A<B<A+2C or A+2C<B,
wherein the cylinder restricts movement of the first stator magnet and the second stator magnet in a plane perpendicular to the longitudinal direction, and a repulsive magnetic force between the mover magnet and the first stator magnet and the second stator magnet restricts movement of the first stator magnet and the second stator magnet in the longitudinal direction.

17. The method for manufacturing a linear vibration motor according to claim 16, further comprising placing an adhesive between the first stator magnet and the casing and between the second stator magnet and the casing.
